(19) United States
(12) Patent Application Publication
(10) Pub. No.: US 2017/0206089 A1
(43) Pub. Date: Jul. 20, 2017

(54) INFORMATION PROCESSING APPARATUS AND COMPUTATIONAL METHOD

(71) Applicant: FUJITSU LIMITED, Kawasaki-shi (JP)

(72) Inventor: Akira HOSOI, Atsugi (JP)

(73) Assignee: FUJITSU LIMITED, Kawasaki-shi (JP)

(21) Appl. No.: 15/373,147

(22) Filed: Dec. 8, 2016

(30) Foreign Application Priority Data
Jan. 20, 2016 (JP) 2016-008801

(51) Int. Cl. G06F 9/38; G06F 9/30

(52) U.S. Cl. CPC G06F 9/3887; G06F 9/3001; G06F 17/5009

(57) ABSTRACT

A storage unit stores a compressed matrix obtained by removing elements with zero values from a coefficient matrix and compressing the coefficient matrix in a direction that reduces the number of columns. A computing unit obtains a row group including a plurality of rows from the U-th row (U is an integer of one or greater) to the V-th row (V is an integer greater than U) from the compressed matrix, reorders elements within each row of the row group so as to collectively place first elements of the row group corresponding to elements belonging to columns different from the U-th to V-th columns of the coefficient matrix, in the same columns of the compressed matrix, and in an operation using the compressed matrix, performs operations respectively on a plurality of first elements that are continuous in the column direction in the row group, using an SIMD instruction.

### CROSS-REFERENCE TO RELATED APPLICATION

This application is based upon and claims the benefit of priority of the prior Japanese Patent Application No. 2016-008801, filed on Jan. 20, 2016, the entire contents of which are incorporated herein by reference.

### FIELD

The embodiments discussed herein relate to an information processing apparatus and a computational method.

### BACKGROUND

In numerical simulations, such as fluid analysis or structural analysis, to solve simultaneous linear equations may be the most time-consuming part. Therefore, it is very important to improve the calculation speed for solving simultaneous linear equations.

Simultaneous linear equations are represented by a matrix equation: “Ax=b”. “A” denotes a coefficient matrix, and “x” and “b” are column vectors. In general, the coefficient matrix A in simultaneous linear equations included in a numerical simulation is a matrix in which most of the elements are zero. Such a matrix is called a sparse matrix.

To solve simultaneous linear equations in which a coefficient matrix is a sparse matrix, an iterative method which is a solving algorithm specialized for sparse matrices is used. For example, the Gauss-Seidel method is one of iterative methods for solving simultaneous linear equations.

For calculating approximate solutions of simultaneous linear equations, use of an iterative method in which approximate solutions do not easily diverge may result in low efficiency of parallel computing. Use of an iterative method that achieves very efficient parallel computing may cause approximate solutions to diverge. Therefore, computational methods that improve the parallel efficiency while reducing the divergence have been considered.

See, for example, Japanese Laid-open Patent Publication No. 2015-135621.

Recent processors, such as Graphics Processing Unit (GPU) or Central Processing Unit (CPU), normally support Single Instruction Multiple Data (SIMD) instructions. The SIMD width which represents the number of operations to be executed by one SIMD instruction tends to be wider, like four to eight. Therefore, as a method for storing a sparse matrix, methods suitable for such wide SIMD instructions are more and more used.

As a data structure for the coefficient matrix A that is a sparse matrix, there is a data structure in which only the positions and values of non-zero elements, whose values are not zero, are stored. For example, elements with zero values are removed from a coefficient matrix that is a sparse matrix. At this time, the remaining elements are shifted to the left. This greatly reduces the number of columns in the coefficient matrix. Then, by storing the values of the elements in a memory so that a plurality of multiplications respectively using a plurality of elements placed in a column direction in a matrix multiplication operation are executable using one SIMD instruction, it is possible to perform the matrix calculation, using SIMD instructions effectively.

However, in the case of solving simultaneous linear equations using the Gauss-Seidel method, it is difficult to use SIMD instructions effectively. Taking the number of calculation iterations as K (K is an integer of one or greater), the Gauss-Seidel method calculates a plurality of linear equations in a predetermined order in the K-th calculation. At this time, for some of the values included in each linear equation, results of other linear equations already obtained in the K-th calculation are substituted. Therefore, it is not possible to perform, in parallel, a certain linear equation and another linear equation whose result is to be used in the certain linear equation. Calculations that are not executable in parallel are not executable simultaneously using an SIMD instruction. Therefore, a calculation process to solve simultaneous linear equations using the Gauss-Seidel method does not good use of SIMD instructions or does not achieve sufficiently fast processing.

### SUMMARY

According to one aspect, there is provided an information processing apparatus including: a memory which stores therein a compressed matrix, the compressed matrix being obtained by removing elements with zero values from a coefficient matrix and compressing the coefficient matrix in a direction that reduces a number of columns; and a processor which performs a process including obtaining a row group including a plurality of rows from a U-th row (U is an integer of one or greater) to a V-th row (V is an integer greater than U), from the compressed matrix, reordering elements within each row of the row group so as to collectively place first elements of the row group in same columns of the compressed matrix, the first elements corresponding to elements belonging to columns different from U-th to V-th columns of the coefficient matrix, and performing operations respectively on a plurality of continuous first elements that are continuous in a column direction in the row group, using a Single Instruction Multiple Data (SIMD) instruction in an operation using the compressed matrix.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a functional configuration of an information processing apparatus according to a first embodiment;

FIG. 2 illustrates an exemplary configuration of a system according to a second embodiment;

FIG. 3 illustrates an exemplary hardware configuration of a management node;

FIG. 4 is a view illustrating a matrix equation which represents simultaneous linear equations;

FIG. 5 is a view illustrating an example of compression of a coefficient matrix;

FIG. 6 illustrates an example of an order of access to stored elements;

FIG. 7 illustrates an example of a portion where calculations are performed using SIMD instructions;

FIG. 8 illustrates an example of a processing routine by the Gauss-Seidel method;

FIG. 9 is a block diagram illustrating functions of the management node;

FIG. 10 is a flowchart illustrating an example of an SIMDization process;

FIG. 11 is a flowchart illustrating an example of a compressed matrix generation process;

FIG. 12 is a flowchart illustrating an exemplary process of obtaining the number of non-zero elements and the maximum value for the number of non-zero elements;

FIG. 13 is a flowchart illustrating an example of a partial SIMDization process;

FIG. 14 is a flowchart illustrating an example of a FIND process;

FIG. 15 is a flowchart illustrating an example of a SWAP process;

FIG. 16 illustrates an example of generation of compressed matrices;

FIG. 17 illustrates an example of reordering elements;

FIG. 18 illustrates an example of partial SIMDization;

FIG. 19 illustrates an example of storing Acol after the partial SIMDization;

FIG. 20 illustrates an example of access made during analysis; and

FIG. 21 illustrates an example of reordering according to a third embodiment.

### DESCRIPTION OF EMBODIMENTS

Several embodiments will be described below with reference to the accompanying drawings, wherein like reference numerals refer to like elements throughout. It is noted that one or more of the embodiments may be combined as long as the combined embodiments are not mutually exclusive.

### First Embodiment

First, a first embodiment will be described.

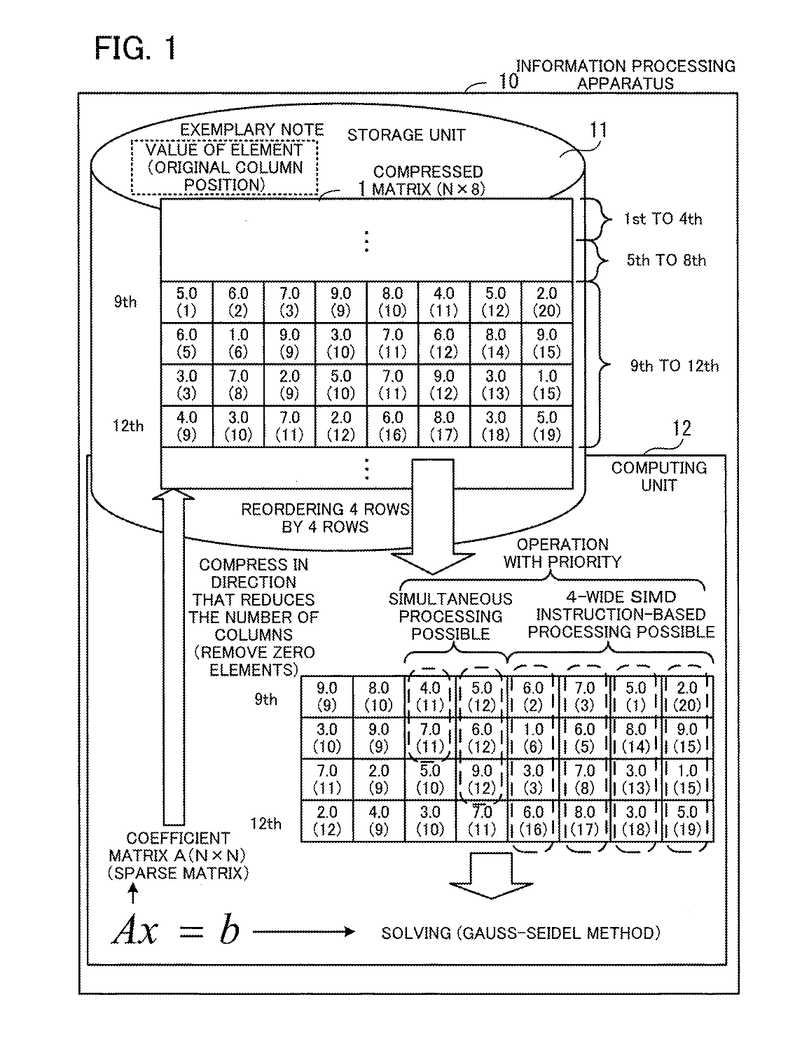

FIG. 1 illustrates an example of a functional configuration of an information processing apparatus according to the first embodiment. An information processing apparatus 10 solves simultaneous linear equations. The information processing apparatus 10 is a computer that is provided with a processor, a memory, a storage device, and others, for example. The information processing apparatus 10 may be a computer system including a plurality of computers. Simultaneous linear equations are represented by a matrix equation: “Ax=b”. “A” denotes a coefficient matrix, and “x” and “b” are column vectors. The element values of the coefficient matrix A and the element values of the vector b are set in advance. The information processing apparatus 10 calculates the element values of the vector x that satisfy the matrix equation. Note that the coefficient matrix A is a sparse matrix in which most of the elements are “0”.

The storage unit 11 stores therein a compressed matrix 1 that is generated by removing elements with zero values from the coefficient matrix A and compressing the coefficient matrix A in a direction that reduces the number of columns (in a row direction). Also, the storage unit 11 may store therein the coefficient matrix A and the vector b.

The computing unit 12 compresses the coefficient matrix A in a direction that reduces the number of columns. For example, the computing unit 12 removes elements with zero values from the coefficient matrix A, and shifts the remaining elements to the left in a row direction. Thereby, the compressed matrix 1, which is obtained by reducing the number of columns from the coefficient matrix A, is generated. Referring to the example of FIG. 1, the coefficient matrix A with N rows and N columns (N is an integer of one or greater) is compressed into the compressed matrix 1 with N rows and 8 columns.

Each element of the compressed matrix 1 is associated with the column position (i.e., which column counted from the left) of its corresponding element of the coefficient matrix A. Referring to the example of FIG. 1, a column position is indicated in parentheses of each element in the compressed matrix. The correspondence between each element of the compressed matrix 1 and the column position of its corresponding element of the coefficient matrix A may be registered in a matrix (a column-position matrix) having the same size as the compressed matrix 1, for example. In this case, the computing unit 12 generates the compressed matrix 1 and the column-position matrix when compressing the coefficient matrix A. The computing unit 12 stores the generated compressed matrix 1 and the column-position matrix in the storage unit 11.

Further, the computing unit 12 solves the simultaneous linear equations using the compressed matrix 1. To this end, the computing unit 12 uses the Gauss-Seidel method, for example. More specifically, the computing unit 12 sets the initial value for each element of the vector x. The initial value may be set to “0” or another value. Then, the computing unit 12 divides the compressed matrix 1 into a plurality of row groups each including a prescribed number of rows (for example, four rows). Then, the computing unit 12 performs product-sum operation in order from the top row group. In the example of FIG. 1, the computing unit 12 performs the product-sum operation on a row group of the 1st to 4th rows. The computing unit 12 then performs the product-sum operation on a row group of the 5th to 8th rows, and then performs the product-sum operation on a row group of the 9th to 12th rows. After that, the product-sum operation is repeated in the same way in order from an upper row group.

The computing unit 12 obtains solutions using an iterative method. In this case, the product-sum operation is performed on each row of the compressed matrix 1, taking the value of the element in the same row of the vector x as an unknown value, to thereby calculate the unknown value. For example, the product-sum operation is performed on, for example, the elements in the 9th row of the compressed matrix 1, to calculate the value of the element in the 9th row of the vector x. The value of each element of the vector x is updated each time a new value is calculated. The value of each element of the vector x is calculated iteratively in this way. When the calculated values of each element are converged (when the same value is calculated as results of iterated calculations), the values of the elements of the vector x obtained this time are taken as the solutions of the simultaneous linear equations.

Note that, in the Gauss-Seidel method, product-sum operation with the vector x is performed in order from the 1st row of the coefficient matrix A, in each cycle of the operation that is iteratively performed. Consider the case of performing the product-sum operation on the X-th row (X is an integer of one or greater). In this case, as the values of the elements in the first to (X−1)-th rows of the vector x that is a column vector, values previously calculated in the same cycle are used. In this connection, in the product-sum operation for the X-th row, the value of the element in the X-th row of the vector x is an unknown value. In addition, as the values of the elements in the (X+1)-th to last rows of the vector x, values calculated in the previous cycle are used.

To efficiently obtain solutions using the Gauss-Seidel method for each row group, the computing unit 12 retrieves a row group of the compressed matrix 1 from the storage unit 11. Then, the computing unit 12 reorders the elements within each row of the row group so as to collectively place elements that are able to be processed in parallel, in the same columns of the rows under the limitations of the Gauss-Seidel method. For example, it is assumed that the computing unit 12 obtains a row group including a plurality of rows from the U-th row (U is an integer of one or greater) to the V-th row (V is an integer greater than U) of the compressed matrix 1. The computing unit 12 then reorders the elements within each row of the obtained row group so as to collectively place elements of the row group corresponding to elements belonging to columns different from the U-th to V-th columns of the coefficient matrix A, in the same columns of the compressed matrix 1.

Then, in the operation using the compressed matrix 1, the computing unit 12 performs operations respectively on a plurality of first elements that are continuous in the column direction in the row group, using an SIMD instruction. For example, in the row group of the 9th to 12th rows, illustrated in FIG. 1, the elements belonging to the right four columns correspond to elements whose column positions are not any of the 9th to 12th columns in the coefficient matrix A. Therefore, the values of the elements of the column vector by which the elements belonging to the right four columns of the row group are multiplied in the matrix calculation are already obtained. Therefore, it is possible to perform operations on the elements in each of the right four columns of the row group, in parallel. Therefore, the computing unit 12 performs the operations on the elements in each of the right four columns of the row group, simultaneously using a 4-wide SIMD instruction. In this connection, the 4-wide SIMD instruction is an instruction in which the number of elements to be subjected to the operations (SIMD width) is four. Hereinafter, a value attached before the term “SIMD instruction” indicates the number of elements to be subjected to operations performed by an SIMD instruction.

The above approach makes it possible to effectively utilize SIMD instructions and efficiently obtain solutions.

In the reordering of elements, the computing unit 12 may place elements of a row group corresponding to the elements on the right side of the diagonal elements in the U-th to V-th rows of the coefficient matrix, in the same columns of the compressed matrix 1. For example, with regard to the 9th row of the coefficient matrix A, the element in the 9th column and the 9th row is a diagonal element. The elements in the 10th and following columns of the 9th row are elements on the right side of the diagonal element. In the matrix operation using elements on the right side of the diagonal element in each row of the coefficient matrix A, the element values of the vector x by which those elements are multiplied are values already calculated in the previous cycle. Therefore, it is possible to perform operations on a plurality of elements on the right side of the diagonal elements simultaneously. In the case where elements of the compressed matrix 1 corresponding to elements on the right side of the diagonal elements in the coefficient matrix A are continuous in the column direction in the row group, the computing unit 12 performs operations respectively on these continuous elements, using an SIMD instruction, in the operation using the compressed matrix 1.

For example, by reordering elements in the 9th to 12th columns in the compressed matrix 1 illustrated in FIG. 1, two elements corresponding to elements placed in the 11th column of the coefficient matrix A are continuous in the 3rd column of the 9th and 10th rows. It is possible to process these two elements simultaneously, and therefore the computing unit 12 performs the operations on these elements, using a 2-wide SIMD instruction. In addition, three elements corresponding to elements placed in the 12th column of the coefficient matrix A are continuous in the 4th column of the 9th to 11th rows. It is possible to perform operations respectively on these three elements simultaneously, and therefore the computing unit 12 performs the operations respectively on these elements, using a 3-wide SIMD instruction. For example, the 2-wide SIMD instruction is achieved by setting two of four elements to values (for example, 1.0) that do not cause exceptions, performing operations on the four elements using a 4-wide SIMD instruction, and not using the operation results of those two elements.

In this connection, when performing operation using the compressed matrix 1, the computing unit 12 performs operations using SIMD instructions before operations that do not use SIMD instructions. After that, the computing unit 12 performs operations that do not use SIMD instructions, on elements in order from the top row. Thereby, the operation employing the Gauss-Seidel method is appropriately performed.

In addition, in the reordering of elements, the computing unit 12 may shift elements which are not able to be processed in parallel to other elements, to the right or left in the row direction in the compressed matrix 1. For example, it is assumed that a row group including a plurality of rows from the U-th row to the V-th row of the compressed matrix 1 is obtained. In this case, in the reordering of elements, the computing unit 12 shifts and places elements of the row group corresponding to elements belonging to any of the U-th to V-th columns of the coefficient matrix, to the left or right end of the compressed matrix 1. This may make it possible to increase the number of continuous elements for which SIMD instructions are executable. As a result, it is possible to promote the efficiency of processing using SIMD instructions.

The computing unit 12 may be implemented by using a processor provided in the information processing apparatus 10, for example. In addition, the storage unit may be implemented by using a memory or storage device provided in the information processing apparatus 10.

### Second Embodiment

The following describes a second embodiment. In the second embodiment, simultaneous linear equations in a numerical simulation, such as a fluid analysis or a structural analysis, are solved efficiently by effectively using SIMD instructions.

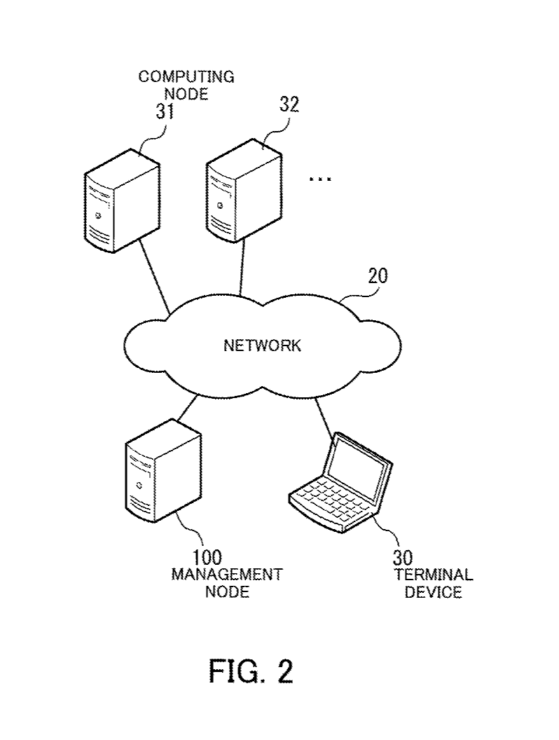

FIG. 2 illustrates an exemplary configuration of a system according to the second embodiment.

Referring to the example of FIG. 2, a plurality of computing nodes 31, 32, . . . , a management node 100, and a terminal device 30 are connected over a network 20. The plurality of computing nodes 31, 32, . . . are a group of computers that perform a numerical simulation in parallel. The management node 100 is a computer to manage submission of jobs to the computing nodes 31, 32, . . . . The terminal device 30 is a computer to enter user instructions to the management node 100.

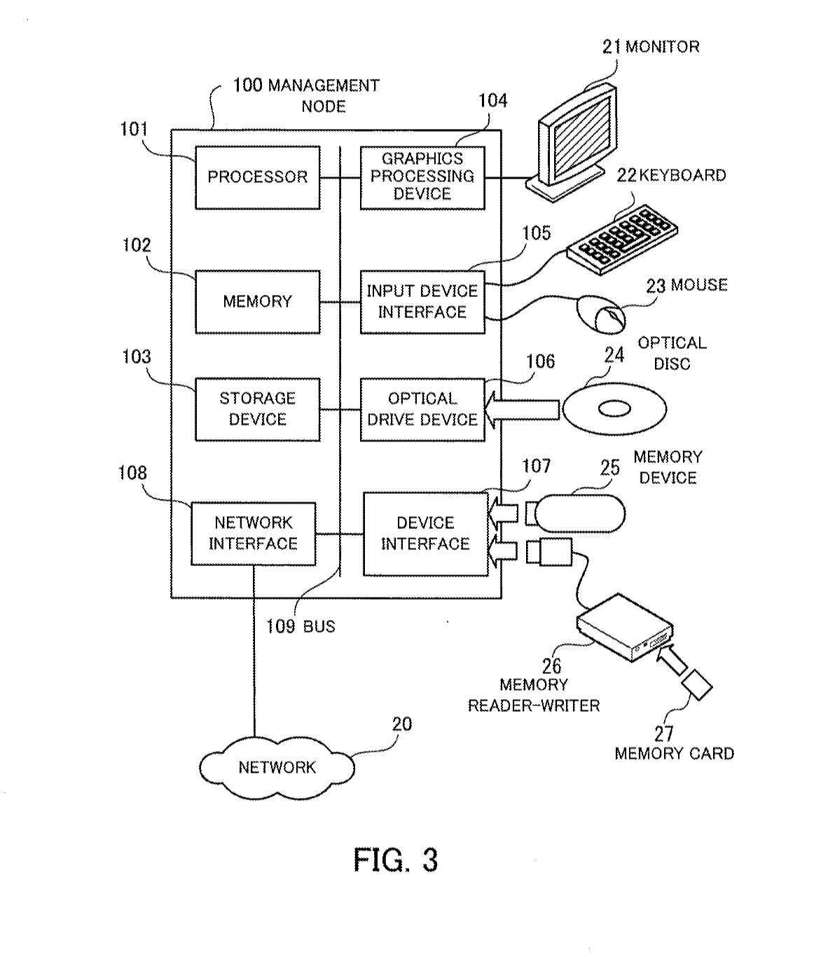

FIG. 3 illustrates an exemplary hardware configuration of a management node. The management node 100 is entirely controlled by a processor 101. A memory 102 and a plurality of peripheral devices are connected to the processor 101 via a bus 109. The processor 101 may be a multiprocessor. The processor 101 is, for example, a CPU, a Micro Processing Unit (MPU), or a Digital Signal Processor (DSP). At least part of functions implemented by the processor 101 executing a program may be implemented by using an Application Specific Integrated Circuit (ASIC), a Programmable Logic Device (PLD), or other electronic circuits.

The memory 102 is used as a main storage device of the management node 100. The memory 102 temporarily stores therein at least part of Operating System (OS) programs and application programs to be executed by the processor 101. Also, the memory 102 stores therein a variety of data that is used by the processor 101 in processing. As the memory 102, a volatile semiconductor storage device, such as a Random Access Memory (RAM), may be used, for example.

The peripheral devices connected to the bus 109 include a storage device 103, a graphics processing device 104, an input device interface 105, an optical drive device 106, a device interface 107, and a network interface 108.

The storage device 103 electrically or magnetically reads and writes data on a built-in storage medium. The storage device 103 is used as an auxiliary storage device of the computer. The storage device 103 stores therein OS programs, application programs, and a variety of data. In this connection, as the storage device 103, a Hard Disk Drive (HDD) or a Solid State Drive (SSD) may be used.

A monitor 21 is connected to the graphics processing device 104. The graphics processing device 104 displays images on the display of the monitor 21 in accordance with instructions from the processor 101. As the monitor 21, a display device using a Cathode Ray Tube (CRT) display or a liquid crystal display device may be used.

A keyboard 22 and a mouse 23 are connected to the input device interface 105. The input device interface 105 outputs signals received from the keyboard 22 and mouse 23 to the processor 101. In this connection, the mouse 23 is one example of pointing devices, and another pointing device may be used. Other pointing devices include touch panels, tablets, touch pads, and trackballs.

The optical drive device 106 reads data from an optical disc 24 with laser light or the like. The optical disc 24 is a portable recording medium on which data is recorded such as to be readable with reflection of light. The optical disc 24 may be a Digital Versatile Disc (DVD), DVD-RAM, CD-ROM (Compact Disc Read Only Memory), CD-R (Recordable), CD-RW (ReWritable), or another.

The device interface 107 is a communication interface that allows peripheral devices to be connected to the management node 100. For example, a memory device or memory reader-writer 26 may be connected to the device interface 107. The memory device 25 is a recording medium having a function of communicating with the device interface 107. The memory reader-writer 26 reads or writes data on a memory card 27, which is a card-type recording medium.

The network interface 108 is connected to the network 20. The network interface 108 communicates data with another computer or communication device over the network 20.

With the above hardware configuration, the processing functions of the second embodiment are implemented. In this connection, the terminal device 30 and the computing nodes 31, 32, . . . may have the same hardware configuration with the management node 100. In addition, the information processing apparatus 10 of the first embodiment may be implemented by using the same hardware as the management node 100 of FIG. 3.

The management node 100 implements the processing functions of the second embodiment by executing a program recorded on a computer-readable recording medium, for example. The program describing the processing content to be executed by the management node 100 may be recorded on a variety of recording media. For example, the program to be executed by the management node 100 may be stored on the storage device 103. The processor 101 loads at least part of the program from the storage device 103 to the memory 102 and then executes the program. Alternatively, the program to be executed by the management node 100 may be recorded on the optical disc 24, memory device 25, memory card 27, or another portable recording medium. The program stored in such a portable recording medium becomes executable after being installed on the storage device 103 under the control of the processor 101, for example. Alternatively, the processor 101 may execute the program directly read from a portable recording medium.

The following describes in detail how to solve simultaneous linear equations. As described earlier, simultaneous linear equations are represented by a matrix equation, “Ax=b”.

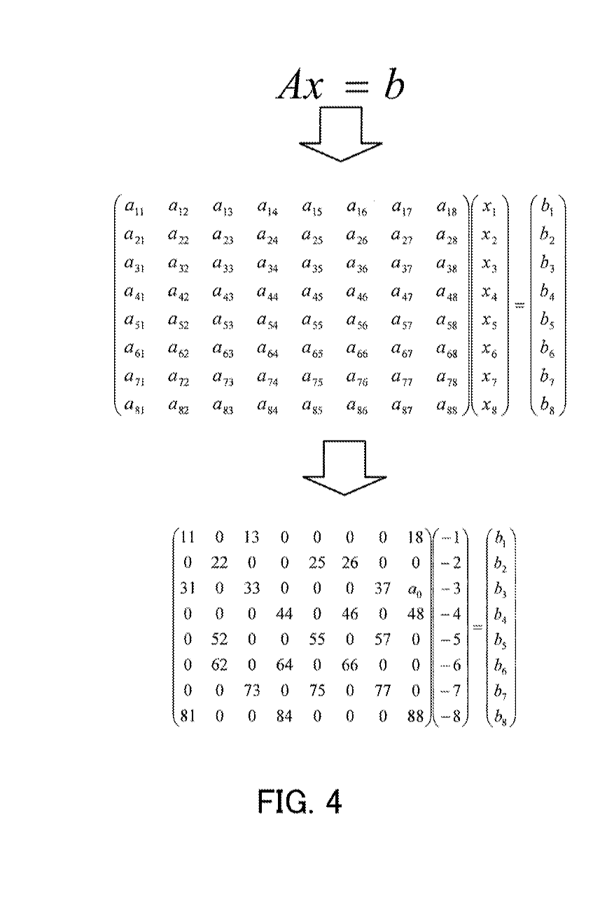

FIG. 4 is a view illustrating a matrix equation which represents simultaneous linear equations. In the example of FIG. 4, eight linear equations are represented by a matrix equation, “Ax=b”. The coefficient matrix A is a square matrix with 8 rows and 8 columns. Each element in the coefficient matrix A is a coefficient set to a prescribed value. The vector x is a column vector including eight unknown values as elements. The vector b is a column vector whose elements are set to prescribed values.

In many cases, in solving simultaneous linear equations in a numerical simulation, the coefficient A is a sparse matrix. Referring to the example of FIG. 4, out of the eight elements in each row of the coefficient matrix A, three elements are non-zero. Such a sparse matrix is compressed by removing elements with zero values, in order to perform calculations efficiently.

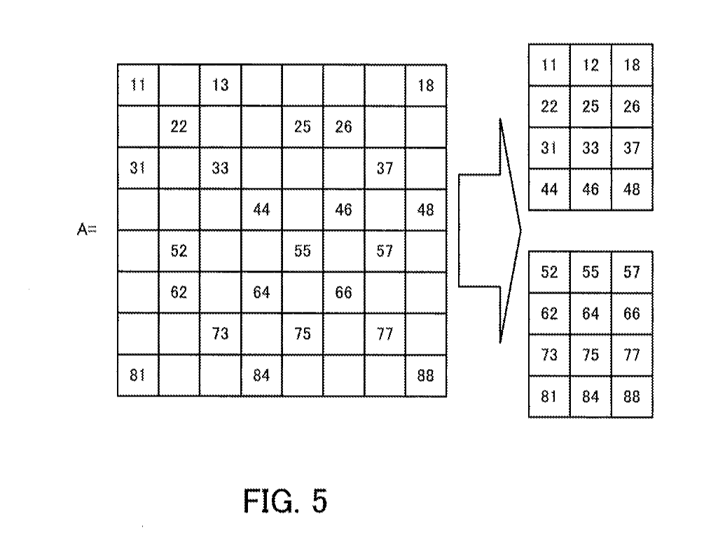

FIG. 5 is a view illustrating an example of compression of a coefficient matrix. FIG. 5 represents each element of the coefficient matrix A in a rectangle. In each rectangle, the value of an element is indicated. In this connection, elements without any values in the rectangles have zero values.

Elements with zero values are removed from each row, and the remaining elements are shifted to the left. In addition, if the maximum SIMD width of the processors of the computing nodes 31, 32, . . . is four, the plurality of rows of the coefficient matrix A are grouped into groups each including four rows. As a result, the first four rows and the next four rows are each compressed into a matrix with four rows and three columns. These compressed matrices are stored in the memory.

In this connection, in the example illustrated in FIGS. 4 and 5, every row of the original coefficient matrix A has three non-zero elements. In general, the maximum value m (m is an integer of one or greater) for the number of non-zero elements per row is obtained, and the coefficient matrix is compressed into matrices each with four rows and m columns, which are then stored.

The matrices generated by the compression are each stored in the memory in such an arrangement as to sequentially read elements that are continuous in the column direction.

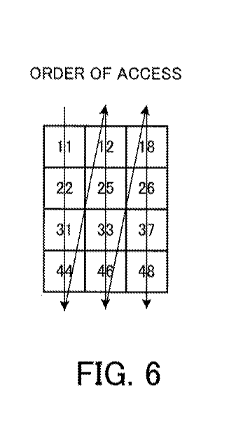

FIG. 6 illustrates an example of an order of access to stored elements. In FIG. 6, an order of access to elements is indicated by arrows. That is, when storing elements with non-zero values of the coefficient matrix A in the memory, the elements are arranged in the order of access illustrated in FIG. 6, and are stored in the memory.

Note that, by using SIMD instructions, it is possible to streamline product-sum operations that use elements whose values have already been obtained out of the elements of the vector x in “Ax=b”.

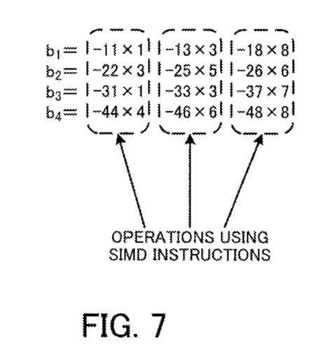

FIG. 7 illustrates an example of a portion where calculations are performed using SIMD instructions. FIG. 7 illustrates an example of calculating the first four elements in a product of the 8×8 coefficient matrix A that is a sparse matrix and a vector x=(−1, −2, −3, −4, −5, −6, −7, −8)^{T}. The matrix product is calculated by product-sum operations of non-zero elements of the coefficient matrix A and their corresponding elements of the vector x. By performing such product-sum operations using CPUs having an SIMD width of four, it is possible to perform loading and operations of data for the portions enclosed by broken lines, using SIMD instructions. That is, four product-sum operations are performed simultaneously. That is, the matrix product is calculated simultaneously for every four rows, using SIMD instructions.

In this connection, there is a considered method of continuously storing the non-zero elements of a sparse matrix in the row direction. However, the number of non-zero elements in each row is not always an integer multiple of the SIMD width (in this case, a multiple of four). If it is not an integer multiple, a portion that is not able to be processed using SIMD occurs, and therefore SIMD instructions may not be used effectively.

In operations using SIMD instructions as illustrated in FIG. 7, a calculation for each row of a coefficient matrix is performed independently. However, the calculation for each row may not be performed independently, depending on an iterative algorithm. For example, the Gauss-Seidel method has a determined execution order of calculations for rows.

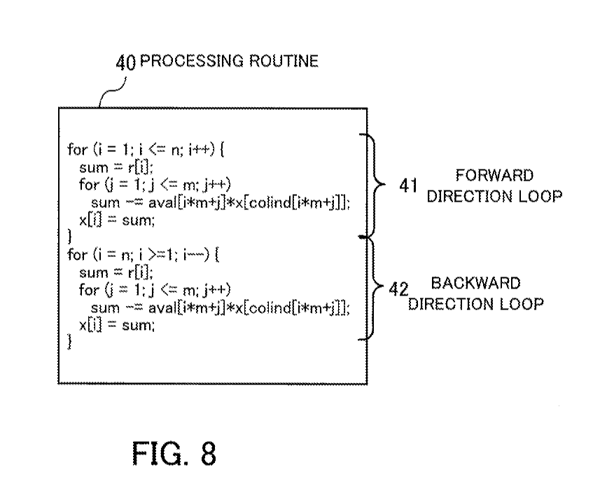

FIG. 8 illustrates an example of a processing routine by the Gauss-Seidel method. In FIG. 8, a processing routine 40 with the Gauss-Seidel method is represented as pseudo codes. The processing routine 40 includes a forward direction loop 41 and a backward direction loop 42. In the processing routine 40, a “for” statement structure, which represents a loop process, is the same as that of the C programming language. In parentheses of the “for” statement, an initialization process of a counter variable, loop continuation conditions, and an update process of the counter variable are described with semicolons between them.

In the processing routine 40, “n” denotes the number of rows in a coefficient matrix. “m” denotes the maximum value for the number of non-zero elements per row. “colind[]” is an array in which the column position of a non-zero element is stored. “*” denotes a multiplication. For example, in the case where the column positions of non-zero elements in the k-th row (k is an integer of one or greater) are “1, 3, 8, . . . ”, colind[] is as follows.

colind[k*m+1]=1

colind[k*m+2]=3

colind[k*m+3]=8

The variable “i” denotes the row number of a row to be subjected to a calculation in a compressed matrix. “x[]” is an array in which an element of the vector x is stored. For example, x[1] represents the value of the first element of the vector x. “aval[]” is an array in which an element of the compressed matrix is stored. Compound assignment operators “−=” indicates that a calculation result of the left-hand side is subtracted from the value of the variable on the right-hand side, and the resulting value is substituted for the variable on the right-hand side.

When “i=k” in this processing routine 40, this means that the k-th row is being processed, and the value of the k-th element x[k] of the vector x is defined. Now, calculations for four rows from the k-th row to the (k+3)-th row in the forward direction loop 41 will be described.

In the Gauss-Seidel method, with respect to the process for the k-th row, the values of x[k+1], x[k+2], x[k+3] to be referenced may be set to values obtained in the previous calculations of the iterative process. Then, x[k] is defined by the process performed on the k-th row. This x[k] is referenced in the processes for the (k+1)-th to (k+3)-th rows. Therefore, out of the (k+1)-th to (k+3)-th rows, the calculation for a row having a non-zero element in the k-th column is not performed in parallel to the calculation for the k-th row.

Similarly, x[k+1] is defined by the process performed on the (k+1)-th row. x[k+1] is referenced in the processes for the k-th, (k+2)-th, and (k+3)-th rows. Therefore, out of the (k+2)-th and (k+3)-th rows, the calculation for a row having a non-zero element in the (k+1)-th column is not performed in parallel to the calculation for the (k+1)-th row.

In this way, on the basis of the positions of columns with non-zero elements in each row, a row for which a calculation is not executable in parallel to the calculation for that row is specified. In the case where a coefficient matrix is a sparse matrix, rows somewhat separate from each other do not include non-zero elements in the same column, and therefore calculations for such rows may be executable independently. Using such a feature, it is possible to streamline processing. For example, the management node 100 scans all of a sparse matrix, reorders the rows of the sparse matrix so that rows that are able to be processed independently are continuous, in order to process the continuous rows independently. This makes it possible to perform the matrix calculation for some continuous rows (for example, four rows) in parallel.

However, the reordering of rows to streamline processing has the following problems.

A cost is incurred for reordering a matrix.

Because of an operation difference caused by greatly changing the original order of calculations, the number of iterations may increase and a long time may be needed to obtain solutions, compared with the case of not reordering rows.

The order of access to data is changed accordingly, which may decrease the data locality.

By contrast, in the second embodiment, the management node 100 reorders non-zero elements within each row, instead of reordering rows. Then, the management node 100 divides continuous N rows into portions which are able to be processed using SIMD (that is, portions in which N rows are processed simultaneously), and portions which are not able to be processed using SIMD, and then processes the former portions simultaneously using SIMD instructions. The effective use of SIMD instructions in this way achieves fast processing. In this connection, the reordering of non-zero elements needs a small processing cost, compared with the reordering of rows, thereby streamlining processing.

Unlike the reordering of rows, the reordering non-zero elements within each row makes a local change in the order of calculations. Therefore, the possibility of increasing the number of iterations or deteriorating the data locality is very low, compared with the reordering of rows. In actual, there is little risk of increasing the number of iterations or deteriorating the data locality due to the reordering of non-zero elements within each row.

The following describes functions of the management node 100 for the case of carrying out a simulation with non-zero elements reordered within each row.

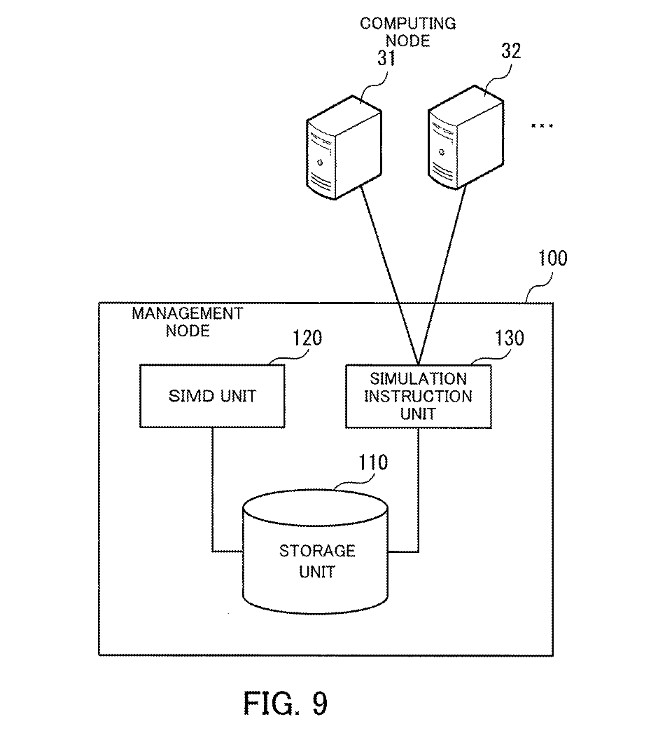

FIG. 9 is a block diagram illustrating functions of the management node. The management node 100 includes a storage unit 110, an SIMD unit 120, and a simulation instruction unit 130.

The storage unit 110 stores information regarding simulation conditions. For example, the storage unit 110 stores therein the coefficient matrix and the vector b illustrated in FIG. 4, and others. In addition, the storage unit 110 stores therein a compressed matrix as illustrated in FIG. 5.

The SIMD unit 120 performs SIMDization of a matrix calculation that is performed in a simulation. In this SIMDization, the SIMD unit 120 compresses a coefficient matrix and reorders non-elements within each row, so as to streamline processing.

The simulation instruction unit 130 instructs the computing nodes 31, 32, . . . , to carry out a simulation using an optimized coefficient matrix.

In this connection, lines connecting units in FIG. 9 are part of communication routes, and communication routes other than the illustrated ones may be configured. In addition, the functions of each unit of FIG. 9 are implemented by causing a computer to execute a program module corresponding to the unit, for example.

The following describes in detail how the SIMD unit 120 performs the SIMDization process.

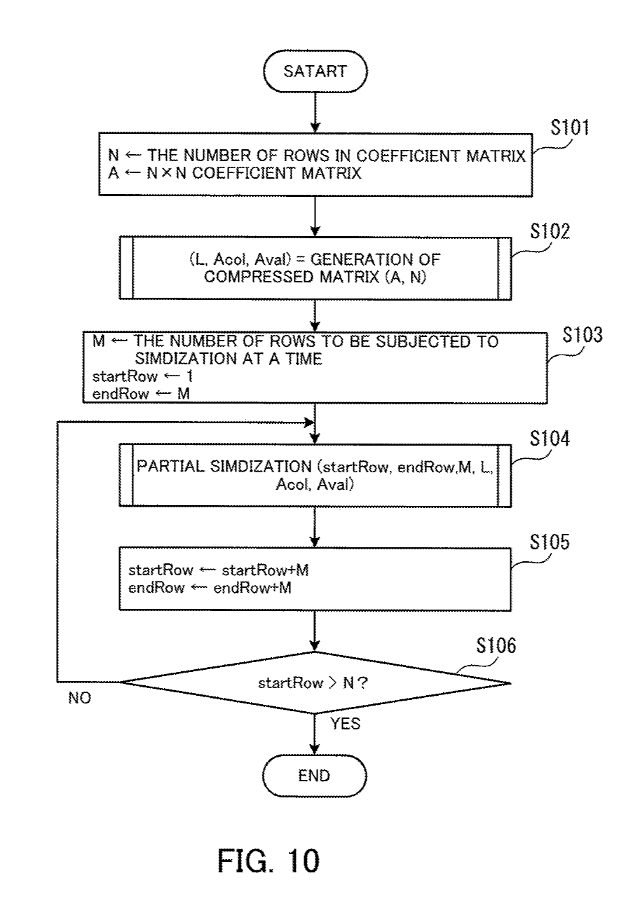

FIG. 10 is a flowchart illustrating an example of an SIMDization process. The process of FIG. 10 will be described step by step.

(Step S101) The SIMD unit 120 takes the number of rows in a coefficient matrix as N, and takes the coefficient matrix with N rows and N columns as A.

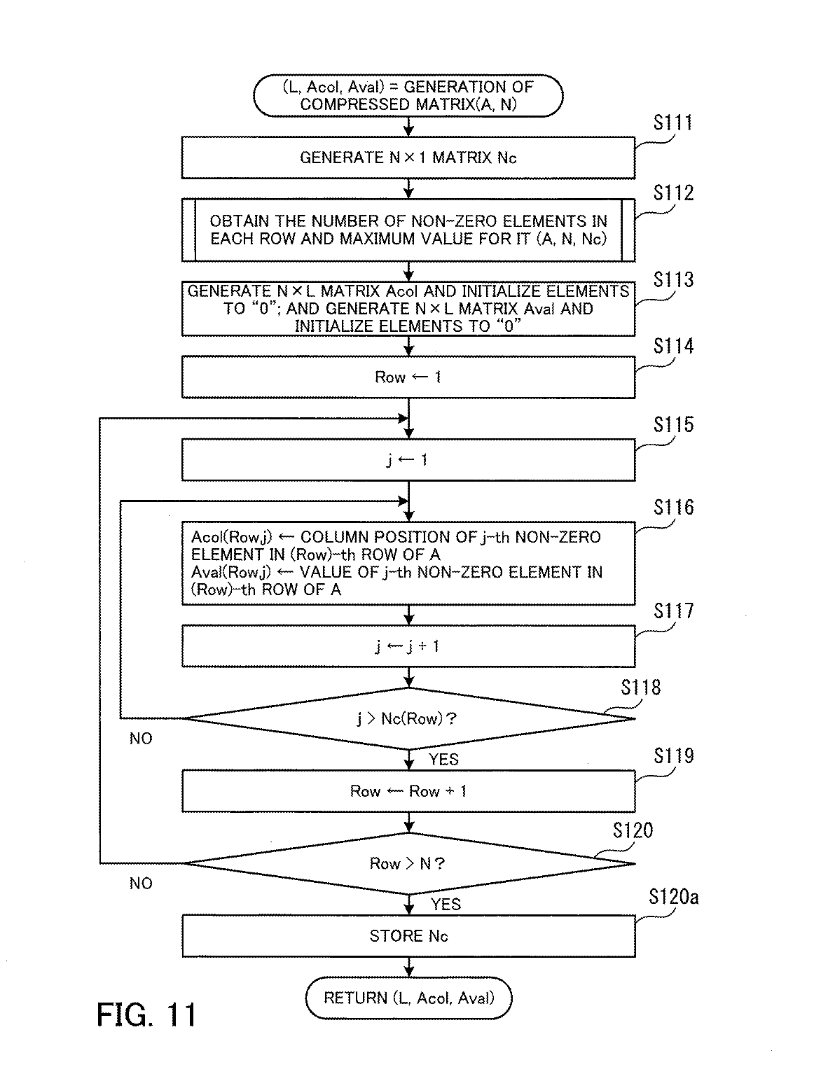

(Step S102) The SIMD unit 120 generates a matrix with N rows and L columns (L is an integer less than or equal to N) by compressing the coefficient matrix A with N rows and N columns, on the basis of the number of rows N. The compression is a process to remove elements with zero values from each row, and shift the remaining non-zero elements to the left, as illustrated in FIG. 5. Hereinafter, a matrix generated by the compression process is called a “compressed matrix”. In the second embodiment, a matrix “Acol” and a matrix “Aval” are generated by a compressed matrix generation process. The matrix Acol indicates the position (i.e., which column counted from the left) of each non-zero element in each row of the coefficient matrix. The matrix Aval indicates the value of each non-zero element in each row of the coefficient matrix. These two matrices (Acol and Aval) are compressed matrices. This compressed matrix generation process will be described (with reference to FIG. 11).

(Step S103) The SIMD unit 120 sets the initial values for variables used in the SIMDization. For example, the SIMD unit 120 takes the number of rows to be subjected to partial SIMDization at a time, as a variable M (M is an integer of one or greater). For example, in the case where the partial SIMDization is performed on every four rows, the variable M is set to four. In addition, the SIMD unit 120 sets the initial value regarding a row which is treated as a first row for reordering non-zero elements, for startRow. In the example of FIG. 10, the initial value of startRow is “1”. That is, non-zero elements are reordered in order from the 1st row. Further, the SIMD unit 120 sets the value of the variable M for endRow.

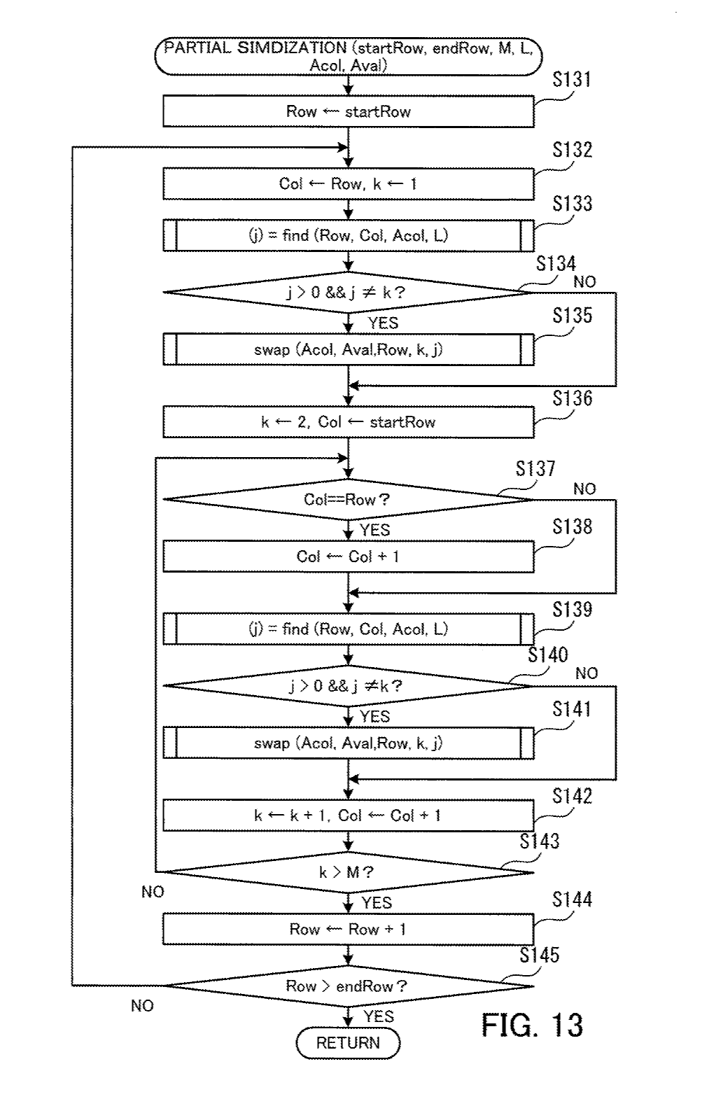

(Step S104) The SIMD unit 120 performs SIMDization on a plurality of rows from the row specified by the startRow value, for the number of rows that is defined by the endRow value. That is, the SIMDization is performed on part of the plurality of rows. Such SIMDization is called partial SIMDization. This partial SIMDization process will be described later (with reference to FIG. 13).

(Step S105) The SIMD unit 120 adds M to the startROW value to set a new startRow value. In addition, the SIMD unit 120 adds M to the endRow value to set a new endRow value.

(Step S106) The SIMD unit 120 determines whether the startRow value is greater than the number of rows N of the coefficient matrix. If the startRow value is less than or equal to the number of rows N, the process proceeds to step S104. If the startRow value is greater than the number of rows N, the SIMDization process is completed.

In this way, the coefficient matrix with N rows and N columns is compressed into a matrix with N rows and L columns, and the compressed matrix with N rows and L columns is divided into submatrices each with M rows, which are then subjected to the partial SIMDization.

The following describes the compressed matrix generation process.

FIG. 11 is a flowchart illustrating an example of a compressed matrix generation process. Hereinafter, the process of FIG. 11 will be described step by step. In the compressed matrix generation process, “Row” (1≦Row≦N) is a variable indicating a row number counted from the top, with respect to the coefficient matrix A (N rows and N columns), matrix Nc (N rows and one column), matrix Acol (N rows and L columns), and matrix Aval (N rows and L columns). “Col” (1≦Col≦N) is a variable indicating a column number counted from the left in the matrix A (N rows and N columns). “j” and “k” (1≦j, k≦L) are variables indicating column numbers counted from the left in the matrix Acol (N rows and L columns) and the matrix Aval (N rows and L columns).

(Step S111) The SIMD unit 120 generates the matrix Nc with N rows and one column.

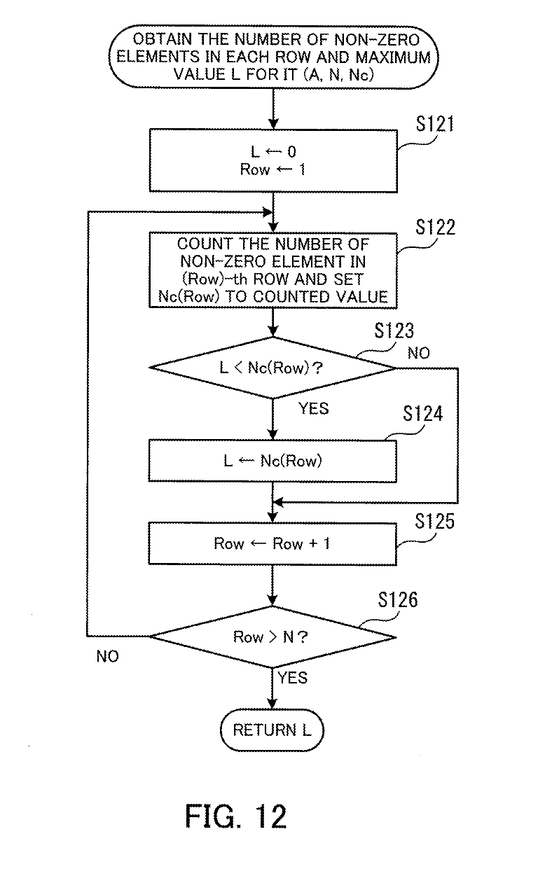

(Step S112) The SIMD unit 120 obtains the number of non-zero elements in each row of the coefficient matrix A and the maximum value L for the number of non-zero elements per row. The SIMD unit 120 stores the number of non-zero elements in each row of the coefficient matrix A, in the matrix Nc. This process will be described in detail later (with reference to FIG. 12).

(Step S113) The SIMD unit 120 generates the matrix Acol with N rows and L columns for storing the column positions of the non-zero elements, and initializes all elements to “0”. In addition, the SIMD unit 120 generates the matrix Aval with N rows and L columns for storing the values of the non-zero elements, and initializes all elements to “0”.

(Step S114) The SIMD unit 120 sets Row to “1”.

(Step S115) The SIMD unit 120 sets j to “1”.

(Step S116) The SIMD unit 120 sets the column position of the j-th non-zero element from the left in the (Row)-th row of the coefficient matrix A, in Acol (Row, j). In addition, the SIMD unit 120 sets the value of the j-th non-zero element from the left in the (Row)-th row of the coefficient matrix A, in Aval (Row, j).

(Step S117) The SIMD unit 120 adds “1” to j.

(Step S118) The SIMD unit 120 determines whether the j value is greater than Nc(Row). Nc(Row) indicates the number of non-zero elements included in the (Row)-th row of the coefficient matrix A. If the j value is greater than Nc(Row), the process proceeds to step S119. If the j value is less than or equal to Nc(Row), the process proceeds to step S116.

(Step S119) The SIMD unit 120 adds “1” to the Row value.

(Step S120) The SIMD unit 120 determines whether the Row value is greater than the number of rows N of the coefficient matrix A. If the Row value is greater than the number of rows N, the process proceeds to step S120a. If the Row value is less than or equal to the number of rows N, the process proceeds to step S115.

Through the above steps S114 to S120, the column positions of the non-zero elements of the coefficient matrix A are set in Acol, and the values of the non-zero elements are set in Aval.

(Step S120a) The SIMD unit 120 stores the matrix Nc in the memory. Then, the SIMD unit 120 outputs the maximum value L for the number of non-zero elements per row, Acol, and Aval, as return values, to the source calling the compressed matrix generation process.

A compressed matrix obtained by compressing the coefficient matrix A is represented by thus generated Acol and Aval. That is, Aval is a matrix obtained by removing elements with zero values from the coefficient matrix A and shifting the non-zero elements to the left. Each element of Acol indicates in which column counted from the left of the coefficient matrix A an element in the same row and the same column of Aval as the element of Acol is placed.

The following describes in detail a process of obtaining the number of non-zero elements in each row and the maximum value for the number of non-zero elements per row.

FIG. 12 is a flowchart illustrating an exemplary process of obtaining the number of non-zero elements and the maximum value for the number of non-zero elements. The process of FIG. 12 will be described step by step.

(Step S121) The SIMD unit 120 sets the maximum value L to the initial value “0”. In addition, the SIMD unit 120 sets Row to the initial value “1”.

(Step S122) The SIMD unit 120 counts the number of non-zero elements in the (Row)-th row of the coefficient matrix A, and sets Nc(Row) to the counted value.

(Step S123) The SIMD unit 120 determines whether Nc(Row) indicating the counting result of step S122 is greater than the current maximum value L. If Nc(Row) is greater than the maximum value L, the process proceeds to step S124. If Nc(Row) is less than or equal to the maximum value L, the process proceeds to step S125.

(Step S124) The SIMD unit 120 sets the maximum value L to the Nc(Row) value.

(Step S125) The SIMD unit 120 adds “1” to the Row value to set a new Row value.

(Step S126) The SIMD unit 120 determines whether Row is greater than the number of rows N of the coefficient matrix A. If Row is greater than the number of rows N, the SIMD unit 120 outputs the maximum value L as a return value of the process, and then the process of obtaining the maximum value L is completed. If Row is less than or equal to the number of rows N, the process proceeds to step S122.

In this way, the number of non-zero elements in each row and the maximum value L for the number of non-zero elements per row are obtained with respect to the coefficient matrix A.

The following describes the partial SIMDization process in detail.

FIG. 13 is a flowchart illustrating an example of a partial SIMDization process. The process of FIG. 13 will be described step by step.

(Step S131) The SIMD unit 120 sets Row to the startRow value.

(Step S132) The SIMD unit 120 sets Col to the Row value, and k to “1”.

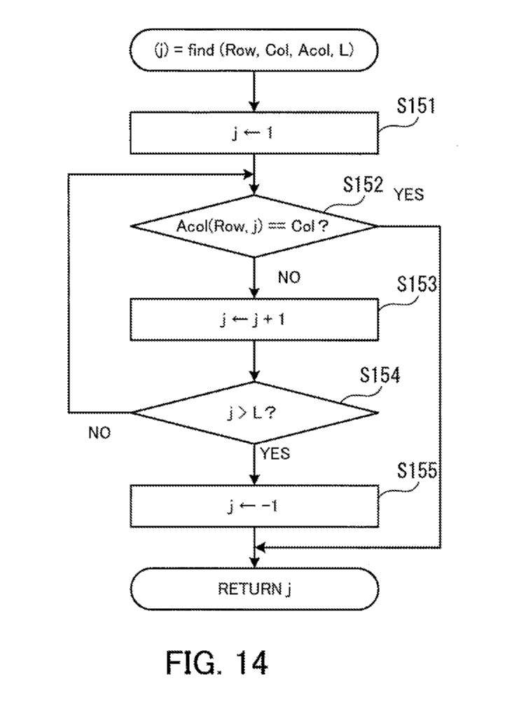

(Step S133) The SIMD unit 120 performs a FIND process. The FIND process is to find which element (column) counted from the left in the (Row)-th row of the matrix Acol indicates the column position of a non-zero element in the (Row)-th row and (Col)-th column of the coefficient matrix. That is, j satisfying “Acol(Row, j)==Col” is found. The FIND process will be described in detail later (with reference to FIG. 14).

In step S132, the same value is set for Row and Col, and therefore j found in step S133 indicates which column counted from the left in the (Row)-th row of the matrix Acol indicates a diagonal element of the coefficient matrix A. If there is no j satisfying “Acol(Row, j)==Col”, j is set to “−1”.

(Step S134) The SIMD unit 120 determines whether j found in the FIND process satisfies conditions where j is greater than zero and is different from k. If the conditions are met, the process proceeds to step S135. If the conditions are not met, the process proceeds to step S136.

In this connection, step S134 has the condition where j is different from k, and if this condition is not met, the next step S135 is skipped. This is because, if j is equal to k, the value swapping in a SWAP process of step S135 is not needed.

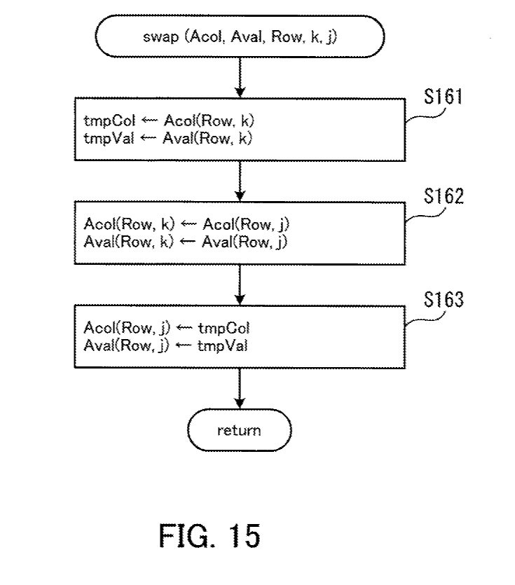

(Step S135) The SIMD unit 120 performs a SWAP process. The SWAP process is to swap values between Acol(Row, k) and Acol(Row, j), and swaps values between Aval(Row, k) and Aval(Row, j). At this time, k=1, and therefore, through the SWAP process of step S135, the diagonal element in the (Row)-th row in the coefficient matrix A is moved to the beginning column of the compressed matrices (Acol, Acol). The SWAP process will be described in detail later (with reference to FIG. 15).

(Step S136) The SIMD unit 120 sets k to “2” and sets Col to the startRow value.

(Step S137) The SIMD unit 120 determines whether Col and Row have the same value. The case where Col and Row have the same value is that an element in the (Row)-th row and the (Col)-th column of the coefficient matrix A is a diagonal element. The diagonal element has already been subjected to the reordering process of steps S132 to S135. Therefore, if Col and Row have the same value, the process proceeds to step S138.

If Col and Row have different values, the process proceeds to step S139.

(Step S138) The SIMD unit 120 adds “1” to the Col value to thereby set a new Col value.

(Step S139) The SIMD unit 120 performs the FIND process. Thereby, j indicating which element (column) counted from the left in the (Row)-th row in the matrix Acol indicates the column position of the non-zero element in the current (Row)-th row and (Col)-th column.

(Step S140) The SIMD unit 120 determines whether j found by the FIND process satisfies the conditions where j is greater than zero and is different from k. If the conditions are met, the process proceeds to step S141. If the conditions are not met, the process proceeds to step S142.

(Step S141) The SIMD unit 120 performs the SWAP process. Through the SWAP process, the SIMD unit 120 swaps values between Acol(Row, k) and Acol(Row, j) and swaps values between Aval(Row, k) and Aval(Row, j).

(Step S142) The SIMD unit 120 adds “1” to the k value and adds “1” to the Col value.

(Step S143) The SIMD unit 120 determines whether the k value is greater than the M value. If the k value is greater than the M value, the process proceeds to step S144. If the k value is less than or equal to the M value, the process proceeds to step S137.

(Step S144) The SIMD unit 120 adds “1” to the Row value.

(Step S145) The SIMD unit 120 determines whether the Row value is greater than the endRow value. If the Row value is greater than the endRow value, the partial SIMDization process is completed. If the Row value is less than or equal to the endRow value, the process proceeds to step S132.

As described above, the partial SIMDization is performed on the compressed matrices with N rows and L columns, for every M rows. That is, by reordering the elements of two matrices (Acol and Aval) each with N rows and L columns generated by the compressed matrix generation process (FIG. 11), operations are partly performed using SIMD instructions. More specifically, with the process of FIG. 11, the partial SIMDization is performed on the M rows from the (startRow)-th row to the (endRow)-th row. That is, the column positions and values of the diagonal elements in the rows from the (startRow)-th row to the (endRow)-th row of the coefficient matrix A are stored in Acol(startRow:endRow, 1) and Aval(startRow:endRow, 1). In addition, the column positions and values of non-zero elements in the same columns as the diagonal elements in the rows from the startRow row to the endRow row are stored in Acol(startRow:endRow, 2:M) and Aval(startRow:endRow, 2:M).

The following describes the FIND process in detail.

FIG. 14 is a flowchart illustrating an example of a FIND process. The process of FIG. 14 will be described step by step.

(Step S151) The SIMD unit 120 sets j to “1”.

(Step S152) The SIMD unit 120 determines whether a condition of “Acol(Row, j)==Col” is met. In the case where this condition is met, the FIND process is completed. If the condition is not met, the process proceeds to step S153.

(Step S153) The SIMD unit 120 adds “1” to the j value.

(Step S154) The SIMD unit 120 determines whether the j value is greater than the L value. If the j value is greater than the L value, the process proceeds to step S155. If the j value is less than or equal to the L value, the process proceeds to step S152.

(Step S155) The SIMD unit 120 sets j to “−1”, and then the FIND process is completed.

In this way, it is found where in the (Row)-th row of the matrix Acol the colum position of the non-zero element in the (Row)-th row and (Col)-th column of the coefficient matrix A is stored. Then, if j satisfying “Acol(Row, j)==Col” is found, the j value is output as a return value. If the element in the (Row)-th row and (Col)-th column is not non-zero, j=−1 is output as a return value.

The following describes the SWAP process.

FIG. 15 is a flowchart illustrating an example of a SWAP process. The process of FIG. 15 will be described step by step.

(Step S161) The SIMD unit 120 sets tmpCol to the Acol(Row, k) value. In addition, the SIMD unit 120 sets tmpVal to the Aval(Row, k) value.

(Step S162) The SIMD unit 120 sets Acol(Row, k) to the Acol(Row, j) value, and sets Aval(Row, k) to the Aval(Row, j) value.

(Step S163) The SIMD unit 120 sets Acol(Row, j) to the tmpCol value, and sets Aval(Row, j) to the tempVal value.

In this way, values are swapped between Acol(Row, k) and Acol(Row, j), and values are swapped between Aval (Row, k) and Aval (Row, j).

The SIMDization of a matrix calculation for solving simultaneous linear equations is achieved with the processes described in FIGS. 10 to 15. Hereinafter, a concrete example of the SIMDization will be described.

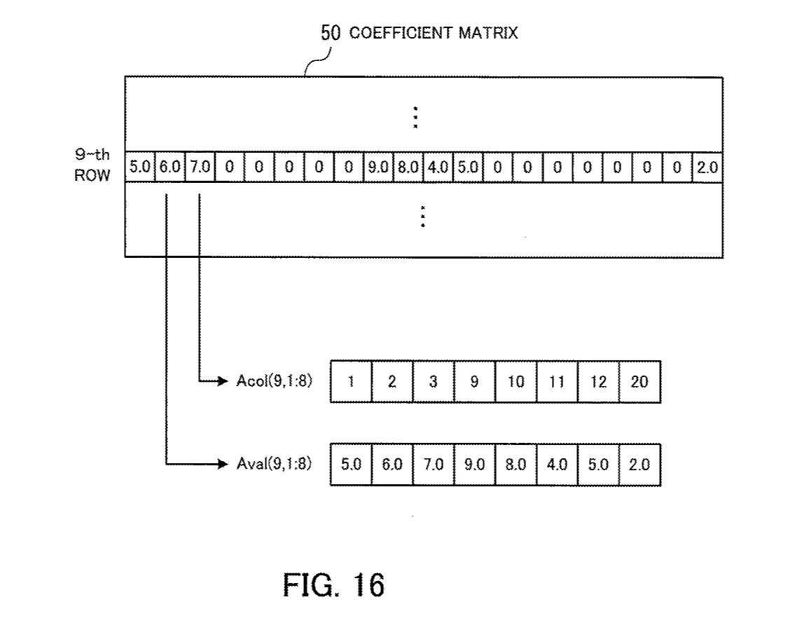

FIG. 16 illustrates an example of generation of compressed matrices. FIG. 16 illustrates the case where the 9th row of a coefficient matrix 50 is compressed.

For example, in the 9th row of the coefficient matrix 50 (N rows and N columns), there are non-zero elements in the 1st, 2nd, 3rd, 9th, 10th, 11th, 12th, and 20th columns. The values of these non-zero elements are 5.0, 6.0, 7.0, 9.0, 8.0, 4.0, 5.0, and 2.0, respectively. In this case, the column positions at which the non-zero elements exist in the 9th row of the coefficient matrix 50 are set in Acol(9, 1:8). In addition, the values of the non-zero elements in the 9th row of the coefficient matrix 50 are set in Aval(9, 1:8). In this example, the maximum value L for the number of non-zero elements per row is “8”.

Similarly, every row of the coefficient matrix is compressed in the same way as the 9th row illustrated in FIG. 16, thereby generating compressed matrices.

After the compressed matrices are generated, partial SIMDization is performed on every several rows. For example, in the case of M=4, the partial SIMDization is performed on every four rows, like the 1st to 4th rows, the 5th to 8th rows, the 9th to 12th rows, . . . . In the partial SIMDization, the elements within each row are reordered, with respect to Acol and Aval.

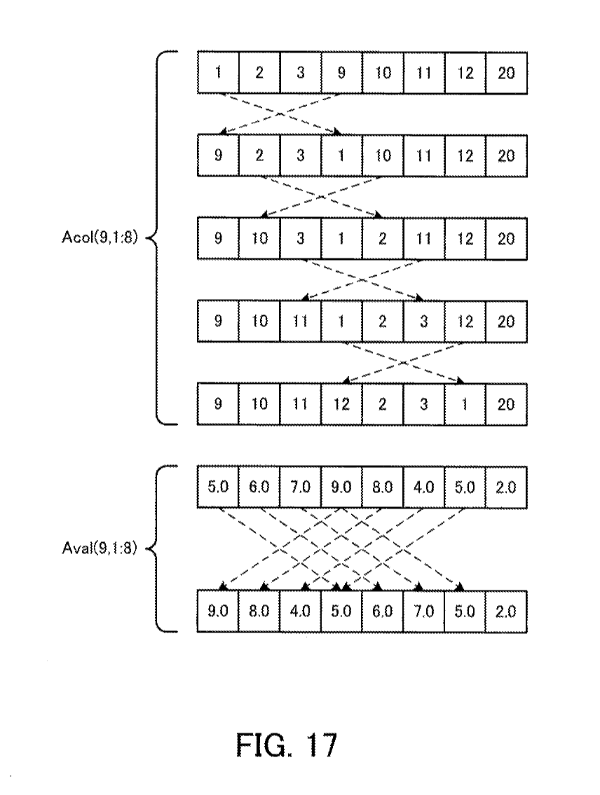

FIG. 17 illustrates an example of reordering elements. FIG. 17 illustrates an example of reordering elements in the 9th row. The SIMD unit 120 reorders elements in the 9th row of each of Acol and Aval, in accordance with the procedure of FIG. 13. In the 9th row of Acol, the value of an element indicating the column position “9” of the diagonal element of the coefficient matrix 50 is swapped with the value of the element in the 1st column. Then, the value of an element indicating the column position “10” of the 10th column of the coefficient matrix 50 is swapped with the value of the element in the 2nd column. Then, the value of an element indicating the column position “11” of the 11th column of the coefficient matrix 50 is swapped with the value of the element in the 3rd column. Finally, the value of an element indicating the column position “12” of the 12th column of the coefficient matrix 50 is swapped with the value of the element in the 4th column.

Through this reordering, the elements of Acol indicating the column positions of the 9th to 12th columns of the coefficient matrix 50 are collectively placed in the 1st to 4th columns of Acol. The elements of Aval are reordered in the same way as Acol, as illustrated in FIG. 17.

FIG. 17 illustrates the reordering in the 9th row. The elements in the 10th to 12th rows are reordered in the same way as the 9th row, thereby completing the partial SIMDization regarding the 9th to 12th rows.

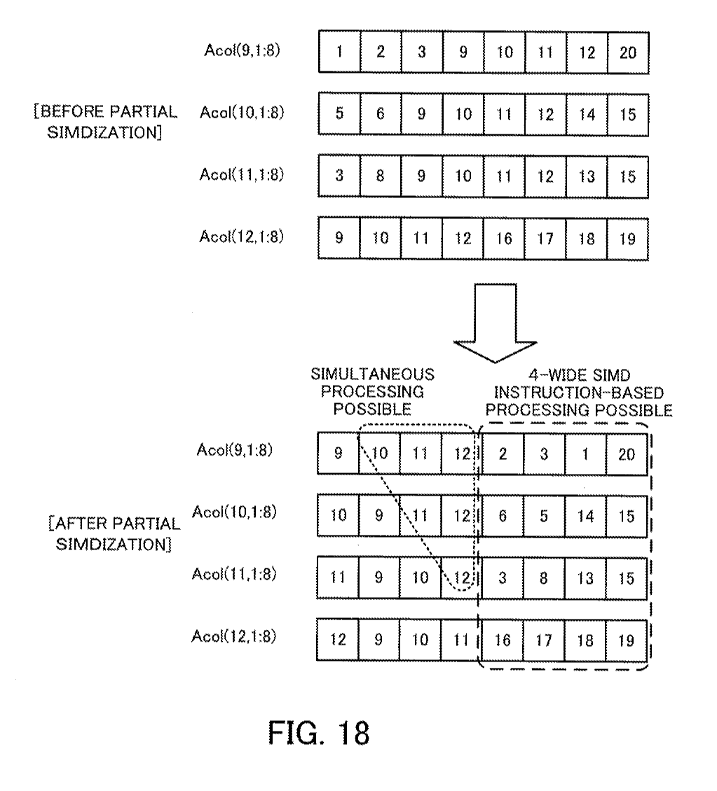

FIG. 18 illustrates an example of partial SIMDization. The upper part of FIG. 18 illustrates the 9th to 12th rows before the partial SIMDization, and the lower part thereof illustrates the 9th to 12th rows after the partial SIMDization. The elements in the 9th to 12th rows of Aval are reordered in the same way as Acol.

As a result of reordering elements in the partial SIMDization in this way, a portion (enclosed by broken line in FIG. 18) where parallel processing using 4-wide SIMD instructions are possible and a portion (enclosed by dotted line in FIG. 18) where parallel processing using 4-wide SIMD instructions is not possible but simultaneous processing is possible are obtained.

By performing the partial SIMDization on a compressed matrix for every M rows, it is possible to efficiently solve simultaneous linear equations in a simulation.

The following describes how an analysis processing program works using an element array in which elements have been reordered by the partial SIMDization. The analysis processing program is executed by the computing nodes 31, 32, . . . , in response to an instruction from the simulation instruction unit 130 of the management node 100, for example.

As the preprocessing of the analysis, the computing nodes 31, 32, . . . that have received the analysis instruction stores the compressed matrices (Acol and Aval) having been subjected to the partial SIMDization, in a memory such as to read elements continuously by SIMD instructions. The following describes how to perform the analysis process, using an example where the computing node 31 performs a simulation.

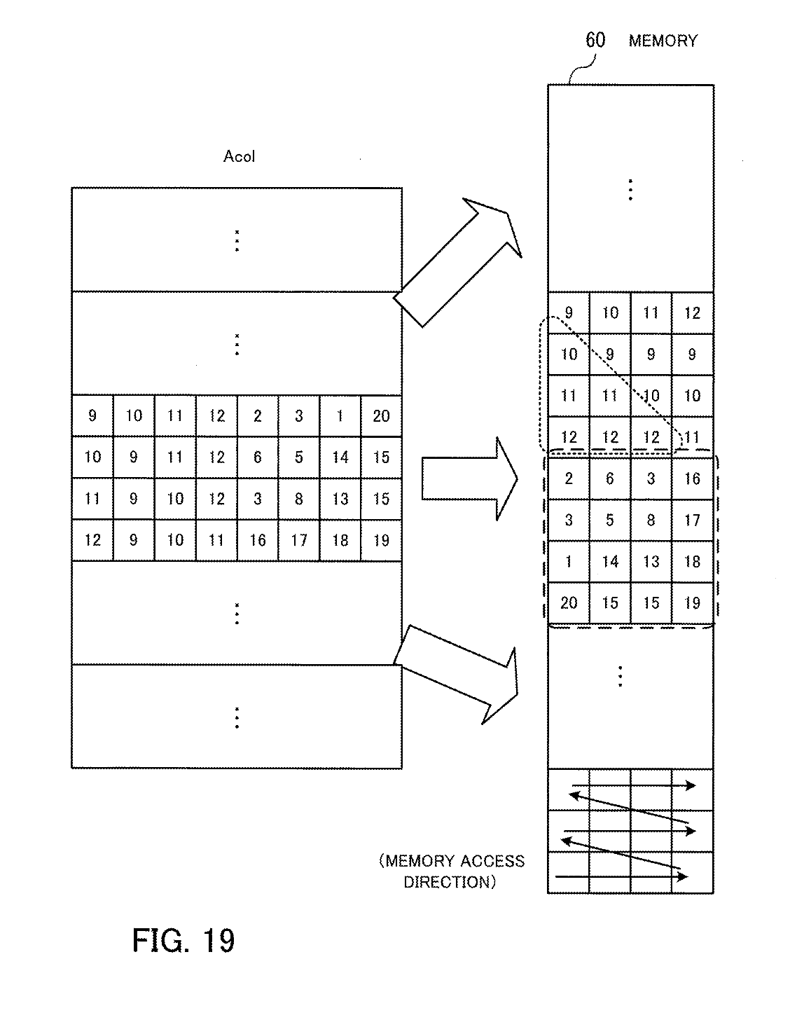

FIG. 19 illustrates an example of storing Acol after partial SIMDization. In FIG. 19, each row of the memory 60 is accessed continuously from left to right. When access to one row in the memory 60 is complete, the row directly on that row is accessed next.

In the case of making memory access in such an order, the computing node 31 replaces the elements of Acol for each row group (four rows and eight columns in the example of FIG. 19) having been subjected to the partial SIMDization. Then, the computing node 31 stores the replaced elements in the memory 60. The computing node 31 performs the replacement in Aval in the same way, and stores the resultant in the memory 60.

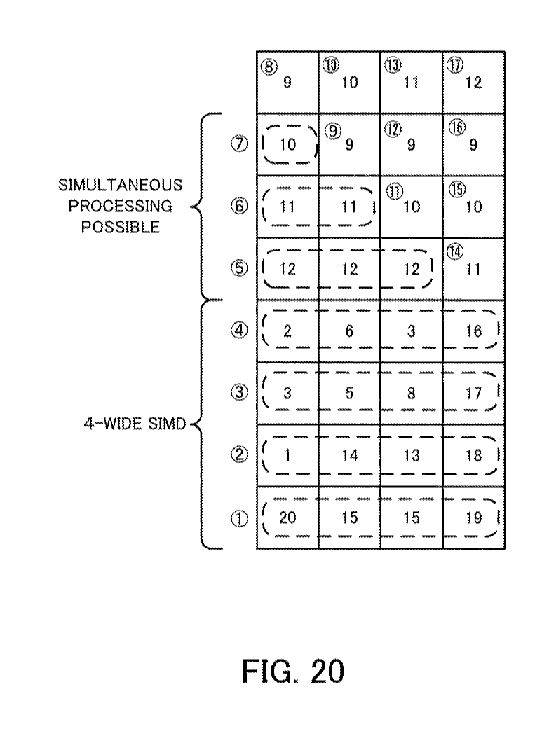

FIG. 20 illustrates an example of access made during analysis. In FIG. 20, elements to be accessed at the same time in response to one instruction are enclosed by broken line. In addition, an order of access from the processor, “1” to “17”, is represented by circled numbers.

For example, the processor of the computing node 31 loads the elements having “1” to “4” in the access order, for every four elements, using four 4-wide SIMD instructions with respect to the column position information (eight rows and four columns) of non-zero elements. Then, the processor loads three elements having “5” in the access order. Then, the processor loads two elements having “6” in the access order. Then, the processor loads the elements having “7” to “17” in the access order, one by one.

In this connection, it is possible to desirably change the access order with respect to the elements having “1” to “7” in the access order of FIG. 20. The processor loads, in order, the elements having “8” to “17” in the access order after operations using the elements having “1” to “7” in the access order.

In this connection, the processor also loads the values of the corresponding non-zero elements of Aval, in the same order as the loading of the elements from Acol. Then, each time the processor loads an element, the processor performs product-sum operation. More specifically, the processor performs the product-sum operation on the element of the vector x corresponding to the value of the element loaded from Acol and the value of the element loaded from Aval. For example, in the case where the processor loads four elements from Aval using a 4-wide SIMD instruction, the processor multiplies each value of the four elements by the value of its corresponding element of the vector x, and adds the multiplication result to the integrated value for the corresponding row of the coefficient matrix.

In this way, the processor of the computing node 31 loads a set of elements that are able to be processed using an SIMD instruction, using the SIMD instruction, and performs the operations on them, thereby performing the analysis process efficiently. In addition, the processor loads elements that are able to be processed in parallel, using an SIMD instruction and performs operations, thereby performing the analysis process efficiently.

As described above, the second embodiment reorders elements within each row of a compressed matrix obtained by compressing a coefficient matrix, to place elements so as to enable parallel processing using SIMD instructions. This makes it possible to perform operations using the SIMD instructions, thereby achieving a fast analysis process.

In this connection, in the second embodiment, the management node 100 performs the SIMDization process, and the computing nodes 31, 32, . . . perform the analysis process. Alternatively, the SIMDization process may be performed by the computing nodes 31, 32, . . . .

### Third Embodiment

The following describes a third embodiment. The third embodiment is designed to reorder elements such that elements that are not able to be processed using SIMD are shifted to the left. In the case of SIMDization for 4-wide SIMD, for example, it may be possible to place elements that are not able to be processed using 4-wide SIMD, in three columns or less on the left.

That is to say, in the second embodiment, a compressed matrix is divided into the following three portions (see FIG. 18).

1. A portion that is able to be processed using 4-wide SIMD.

2. A portion that is not able to be processed using 4-wide SIMD but is able to be processed simultaneously.

3. A portion that is processed sequentially.

By contrast, in the third embodiment, a compressed matrix is divided into “1. A portion that is able to be processed using 4-wide SIMD” and “2. A portion that is processed sequentially.”

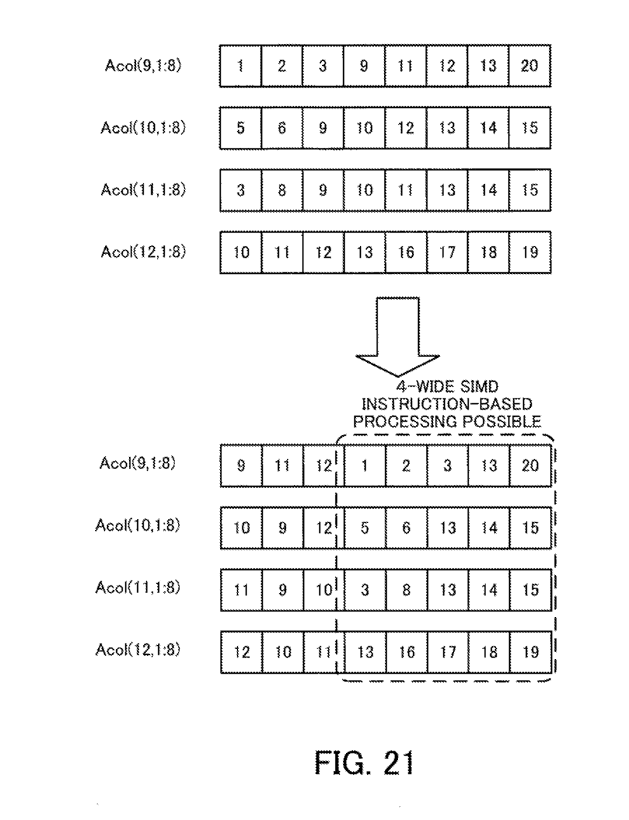

FIG. 21 illustrates an example of reordering according to the third embodiment. For example, the SIMD unit 120 detects the number of elements that are not able to be processed using 4-wide SIMD, for each row. FIG. 21 exemplifies the case where partial SIMDization is performed on each row from the 9th row to the 12th row. In this case, the SIMD unit 120 detects, for each row, the number of elements having any of the values 9 to 12, out of the column positions of the non-zero elements indicated by Acol. Then, the SIMD unit 120 obtains the maximum value nz for the number of elements that are not able to be processed using 4-wide SIMD in each row. In the case where the maximum value nz is four, even the left alignment does not enlarge the size of the portion that is able to be processed using SIMD, and therefore the left alignment is completed.

If the maximum value nz is less than four, the number of columns that are able to be processed using 4-wide SIMD instructions increases by “4-nz” columns. Therefore, in the case where the maximum value nz is less than four, the SIMD unit 120 reorders the non-zero elements within each of the 9th to 12th rows of Acol, so as to place the non-zero elements whose column positions are nine to twelve, only in the left nz columns. In the example of FIG. 21, the maximum value nz is three, and therefore the number of columns (columns enclosed by dotted line in FIG. 21) that are able to be processed using 4-wide SIMD instructions increases by one column, compared with the case of the second embodiment. In this connection, in the (mz+1)-th to (nz)-th columns in which the number of elements that are not able to be processed using 4-wide SIMD is mz (<nz), elements with any column positions may be placed.

With regard to the elements of Aval, the SIMD unit 120 reorders the elements so as to have the same arrangement as the elements of Acol. As a result, a portion that is able to be processed using 4-wide SIMD instructions is enlarged, and the analysis process is further streamlined.

According to one aspect, it is possible to achieve efficient solving using SIMD instructions.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus comprising:
a memory which stores therein a compressed matrix, the compressed matrix being obtained by removing elements with zero values from a coefficient matrix and compressing the coefficient matrix in a direction that reduces a number of columns; and
a processor which performs a process including
obtaining a row group including a plurality of rows from a U-th row (U is an integer of one or greater) to a V-th row (V is an integer greater than U), from the compressed matrix,
reordering elements within each row of the row group so as to collectively place first elements of the row group in same columns of the compressed matrix, the first elements corresponding to elements belonging to columns different from U-th to V-th columns of the coefficient matrix, and
performing operations respectively on a plurality of continuous first elements that are continuous in a column direction in the row group, using a Single Instruction Multiple Data (SIMD) instruction in an operation using the compressed matrix.

2. The information processing apparatus according to claim 1, wherein
the reordering includes collectively placing second elements of the row group in same columns of the compressed matrix, the second elements corresponding to elements placed on a right side of diagonal elements in the rows from the U-th row to the V-th row of the coefficient matrix, and
the performing includes performing, in the operation using the compressed matrix, operations respectively on a plurality of continuous second elements that are continuous in the column direction in the row group, with the SIMD instruction.

3. The information processing apparatus according to claim 1, wherein the operation using the compressed matrix includes performing operations based on SIMD instructions before performing operations that do not use SIMD instructions.

4. The information processing apparatus according to claim 1, wherein the reordering includes placing third elements of the row group to a left or right end of the compressed matrix, the third elements corresponding to elements belonging to any of columns from the U-th column to the V-th column of the coefficient matrix.

5. A computational method comprising:
retrieving, by a processor, from a storage unit storing therein a compressed matrix, a row group including a plurality of rows from a U-th row (U is an integer of one or greater) to a V-th row (V is an integer greater than U) of the compressed matrix, the compressed matrix being obtained by removing elements with zero values from a coefficient matrix and compressing the coefficient matrix in a direction that reduces a number of columns;
reordering, by the processor, elements within each row of the row group so as to collectively place first elements of the row group in same columns of the compressed matrix, the first elements corresponding to elements belonging to columns different from U-th to V-th columns of the coefficient matrix; and
performing, by the processor, operations respectively on a plurality of continuous first elements that are continuous in a column direction in the row group, using a Single Instruction Multiple Data (SIMD) instruction in an operation using the compressed matrix.

6. A non-transitory computer-readable storage medium storing a program that causes a computer to perform a process comprising:
retrieving, from a storage unit storing therein a compressed matrix, a row group including a plurality of rows from a U-th row (U is an integer of one or greater) to a V-th row (V is an integer greater than U) of the compressed matrix, the compressed matrix being obtained by removing elements with zero values from a coefficient matrix and compressing the coefficient matrix in a direction that reduces a number of columns;
reordering elements within each row of the row group so as to collectively place first elements of the row group in same columns of the compressed matrix, the first elements corresponding to elements belonging to columns different from U-th to V-th columns of the coefficient matrix; and
performing operations respectively on a plurality of continuous first elements that are continuous in a column direction in the row group, using a Single Instruction Multiple Data (SIMD) instruction in an operation using the compressed matrix.
